(19) United States
(12) Patent Application Publication
(10) Pub. No.: US 2006/0216392 A1
(43) Pub. Date: Sep. 28, 2006

(54) Nonalcoholic beverage

(76) Inventor: Zurab Tsutsuashvili, Forest Hills, NY (US)

Correspondence Address: Mikhail Shedrinsky, Esq., Suite 5A, 233 Fifth Avenue, New York, NY, 10016, US

(21) Appl. No.: 11/088,067

(22) Filed: Mar. 24, 2005

(51) Int. Cl. A23L 2/00

(52) U.S. Cl. 426/590

(57) ABSTRACT

A method and apparatus for preparing nonalcoholic beverages is characterized by adding to a liquid mixture, which includes a fruit or plant extract, sugar, citric acid, water, and a predetermined amount of bioflavonoids.

### CROSS REFERENCE TO RELATED APPLPICATION

This application is based on and claims priority to Georgian National Applications Ser. No. ______ filed with Georgian Patent Office Mar. 23, 2004 and fully incorporated herein by reference.

### BACKGROUND OF THE INVENTION

1. Field of the Invention

This invention relates to food industry and, in particular, to nonalcoholic beverages.

2. Background of the Invention

Beverages enjoy worldwide sales, and the full mouthfeel of the beverage is very important in its customer acceptance. Some nonalcoholic beverages have a composition containing only natural products, whereas many others are based on artificial additives. While many beverages containing artificial ingredients are very popular, a recent trend in food industry, reflecting the societal health consciousness, has shifted towards healing and health-prophylactic qualities of beverages including only natural ingredients, such as herbs, fruits and vegetables.

One of these plants, Tarragon (Estragon), also known as “Tarhoon” or Artemisia dracunculus, is a small perennial plant of the Asteraceae family. Grown in Russia, Georgia, France, Holland, Hungary and USA, this plant has been the critical component of Tarragon oil characterized by spicy, delicate odor reminiscent of liquorice and sweet basil. It has a dark green viscous oleoresin color and is used mainly in aroma compositions; smaller quantities are employed in perfumery.

Historically, Tarragon has been used in Europe to reduce anorexia, dyspepsia, flatulence, intestinal spasms, nervous digestion, sluggish digestion and urinary tract infection. It may also help reduce premenstrual discomfort and pain with nerves and sciatica. It is neuromuscular, antispasmodic, anti-inflammatory, anti-infectious, antiviral, antibacterial, and prevents fermentation. The ancient Greeks used Tarragon as a remedy for toothache. Recent studies indicate that tarragon contains an anesthetic chemical, eugenol, which is the major constituent of anesthetic clove oil, making its use for temporary pain relief understandable.

A carbonated beverage, based on an extract of tarragon, has been known in Eastern Europe at least for a century. The formula of Tarragon-based beverage is known and includes such ingredients as an extract of tarragon, sugar (10-12 kg), citric acid (100 g), carbon dioxide (2-2.5 kg)-02 1E, mint extract (40-50 g) and oil mint (0.5-0.8 g), the beverage has become widely popular.

Still another carbonated beverage including a fruit-based ingredient, such as berry extract, is also known. To prepare about 100 liters of this beverage, 10 kg of sugar, 12 liters of berry extract, liters sugar, 50 ml of berry ethereal oil, 100 grams of citric acid, and 2 kg of CO₂ are mixed together to form a liquid composition.

However, these beverages do not contain biologically active ingredients and may have low stability and inferior organoleptic qualities. Most importantly, the above-mentioned compositions are associated with formation of an excessive number of free radicals.

Typically, free radicals are formed during the process of the oxidation in the body. In human bodies oxygen is transported through the bloodstream to where it is required for normal cell function. One problem however exists with the oxygen where it could be lacking in the number of electrons it holds. In order to keep the electron states stable the molecules obtain electrons from other molecules, which sets off a chain reaction. When the body oxidizes the food to obtain the nutrients and energy, oxygen is used and unpaired electrons are released. Thus, free radicals are these altered, unpaired oxygen molecules which can cause a great deal of trouble in the body.

The problem arises where there are excessive free radicals in the body which damage the cells and tissues, and the over-abundance of the free radicals create even more free radicals in the body. In very high volumes free radicals can alter the genetic code material of cells themselves. Mutations that are formed by free radicals can lead to leukemia and other types of cancer as well as a host of other diseases. Not only can free radicals cause disease, but they can also damage the protective cell membrane, which, in turn, leads to retention of fluids in the cells involved in the aging process. To fight these free radicals, antioxidants can be taken into the diet, which neutralize and destroy the free radicals, helping to detoxify and protect the body.

A need, thus, exists for nonalcoholic beverages preserving all of the known qualities of plant-based ingredients, but free from the above-discussed drawbacks.

A further need exists for biologically stable nonalcoholic beverages based on plants extract.

Still a further need exists for nonalcoholic beverages based on Tarhoon extract and characterized by superior organoleptic qualities.

Moreover, another need exists for nonalcoholic beverages based on Tarhoon extract and having superior biological stability and health-beneficial qualities.

Additionally, another need exists for nonalcoholic beverage based on a plant-based ingredients and characterized by superior organoleptic and healthful qualities.

### SUMMARY OF THE INVENTION

A nonalcoholic liquid composition prepared in accordance with this invention meets these needs. The inventive composition includes, among others, a sugar syrup prepared in accordance with the known techniques, Tarhoon extract added to the syrup, citric acid, a predetermined amount of softened water and, finally, bioflavonoids. A method of preparing the inventive composition includes sequentially adding each of the above-mentioned ingredients not necessarily in the order indicated above. Upon addition of each new ingredient, the liquid composition is stirred to form a uniform, liquid mass. As a result, the final liquid product has a green color and the combined qualities of aroma and flavor of Tarhoon. However, in contrast to the known beverage, the inventive liquid composition radically minimizes the drawbacks associated with the known beverage due to the presence of bioflavonoids.

Still another nonalcoholic liquid composition is prepared in accordance with the invention and includes about 9.1 liters of Berry Extract, 10.5-11.5 kg of sugar, 0.1-0.2 of citric acid, 0.01-0.02 of bioflavonoids and softened water.

In general, the term bioflavonoids or Vitamin P refers to many different ingredients and include hesperin, hesperidin, eriodictyol, quercetin, quercertrin, rutin etc. This nutrient cannot be manufactured by the body and must be supplied in the diet. It has been found that bioflavonoids of grape have been particularly critical for preparing the liquid composition having high biological stability, and improved organoleptic qualities.

Addition of grape bioflavonoids is not accidental. As is known, daily consumption of red wines has been proved to lower a mortality rate from cardiovascular deceases. It is probable that the bioflavonoid content of the wine, making blood platelets less sticky, is a major contributor to such a beneficial health effect produced by red wines. As such, it is little surprise that addition of grape bioflavonoids drastically improves healthful and organoleptic qualities of the inventive beverage.

Bioflavonoids enhance the action of Vitamin C and for this reason they should be taken together. Thus the beverage, prepared in accordance with the invention, can be effectively used in the treatment of sport injuries as bioflavonoids are pain relieving. Concomitantly, pain in the legs, across the back and prolonged bleeding can be at least minimized due to the consumption of the inventive beverage.

Bioflavonoids may also be active in preserving the structures of capillaries, have an antibacterial effect and promote circulation. They may be indicated in the production of bile, lowering blood cholesterol levels and in the prevention and treatment of cataracts.

Bioflavonoids are thought to enhance the absorption of Vitamin C, and possibly to prolong the effectiveness of it as well. These are super active substances, and can add a great deal to nutritional needs. Furthermore, these active substances can improve health and combat deceases.

These nutrients act together with Vitamin C to help maintain the thin walls of the capillaries, therefore preventing bleeding or bruising. Bioflavonoids have been linked to having an antibacterial effect, stimulating bile production, promoting circulation and even assisting with fighting allergies, asthma etc.

Even more importantly, bioflavonoids are uniquely capable of minimizing generation of free radicals and believed to be instrumental in preventing cancerous tumors.

These and other features and aspects of the present invention will be better understood with reference to the following description, figures, and appended claims.

### BRIEF DESCRIPTION OF THE DRAWINGS

FIG. 1 illustrates a process of preparing a beverage in accordance with one aspect of the invention;

FIG. 2 illustrates a process of preparing a beverage in accordance with a further aspect of the invention.

### DETAILED DESCRIPTION

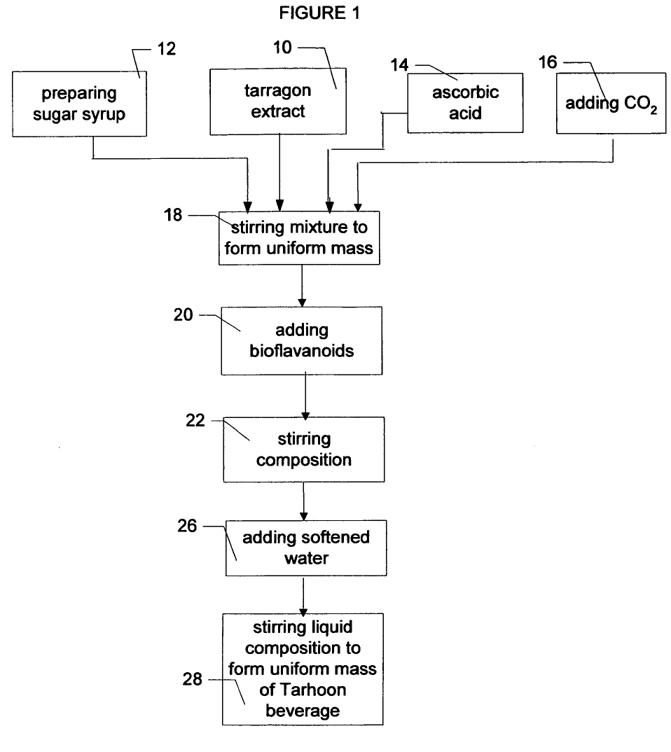

Inventive beverage Tarhoon is based on an extract of Tarragon and prepared in accordance with a process, as is illustrated in FIG. 1. The process of preparing the Tarragon extract, as indicated by step 10, is known and will not be disclosed here in detail. Carbon dioxide, sugar syrup and citric acid are added in accordance with steps 16, 14 and 12, respectively, to the extract, and a composition is stirred, as indicated by step 18 until a uniform liquid mass is formed. Thereafter, upon sequentially adding grape bioflavonoids, as shown by step 20, the liquid composition is again stirred, as indicated by step 22. Finally, adding softened water, as illustrated by step 26, and further stirring the composition complete the process of preparing the inventive beverage.

To prepare about 100 liters of the inventive beverage characterized by Vitamin P activity, it has been found that the above-mentioned ingredients should added be according to the following:

| | |
|---|---|
| Tarhoon extract | about 4-5 liters; |
| Sugar syrup | about 12.3-12.5 kg; |
| Citric acid | about 0.1-0.2 kg; |
| Grape Bioflavonoids | about 0.01-0.02 kg; and |
| Soft Water | about 80-82 l. |

The inventive beverage has excellent organoleptic qualities, which is attributed to the addition of bioflavonoids obtained from grape and characterized by Vitamin P activity. Mainly, bioflavonoids are selected from the group including proanthocyanidins and catechins.

Proanthocyanidins can be found in citrus fruits, blueberries, bilberries, the herbs feverfew and ginkgo, and grape seed extract. While each is a powerful antioxidant, these plants have different physiological effects. Bilberry is a traditional remedy for eye disorders, such as macular degeneration. Feverfew is well documented for its ability to reduce the incidence and severity of migraine headaches, and ginkgo has been shown to increase blood circulation in the brain and to improve memory. Proanthocyanidins are also credited as the nutritional factor that has cardiovascular benefits.

Catehins—including the closely related epigallocatechin-3 gallate (EGCG), epigallocatechin (EGC), and epicatechin-3 gallate (ECG)—also can be found in all of the above mentioned and other fruits and plants. For example, catehins form about 30 percent of the dry weight of green tea leaves. Numerous studies have shown that catechins can prevent free radical damage to cholesterol and lower the risk of heart disease and cancer. Population-based studies have shown that people consuming products rich with catehins have a lower than average risk of heart disease, stroke, and several cancers including esophageal, stomach, and lung cancers.

In addition to the above discussed bioflavonoids, others, such as proanthocyanidins, pycnogenol and kaempferol either alone or in any combination with others flavonoids are known to enhance the ability of Vitamin C to form strong but flexible blood vessel walls. When blood vessel walls are permeable, or leaky, fluid between cells increases and leads to swelling (edema) and inflammation. Bioflavonoids have been found to have a long history of use in preventing capillary fragility and bruising, but some of the most recent research has focused on their anticancer benefits.

Note that grape (including its stem, skin and seeds) is a particularly rich source of bioflavonoids and, for this reason, is a preferred ingredient for preparing the inventive beverage, but other fruits, vegetables, such as radishes, and plants, such as oranges, grapefruit, lemons, limes, green tee and even black tee, can be used as a source of bioflavonoids.

While various percentages of the discussed ingredients can be used for preparation of the inventive beverage, the beverage prepared in accordance with the following examples have been found to have particularly good organoleptic qualities.

### EXAMPLE 1

### This and Other Examples are Given Based on Approximately 100 Liter Total Volume of the Inventive Beverage

| | |
|---|---|
| Sugar | about 12.3 kg; |
| Tarhoon extract | about 4 kg; |
| Citric acid | 0.1 kg; |
| Grape flavonoids | 0.1 kg; and |
| Softened Water | the rest |

### EXAMPLE 2

| | |
|---|---|
| Sugar | about 12.6 kg; |
| Tarhoon extract | about 4.5 kg; |
| Citric acid | 0.15 kg; |
| Grape flavonoids | 0.15 kg; and |
| Softened Water | the rest. |

### EXAMPLE 3

| | |
|---|---|
| Sugar | about 12.9 kg; |
| Tarhoon extract | about 5 kg; |
| Citric acid | 0.2 kg; |
| Grape flavonoids | 0.02 kg; and |
| Softened Water | the rest. |

To prepare the inventive beverage, the above-indicated amount of sugar is used for making syrup. The rest of the mentioned ingredients are sequentially added to the sugar syrup. Optionally, a natural color modifier, preferably, having the green color, may be added to the liquid composition. As a result, a prepared green beverage is characterized by the taste and aroma of Tarhoon.

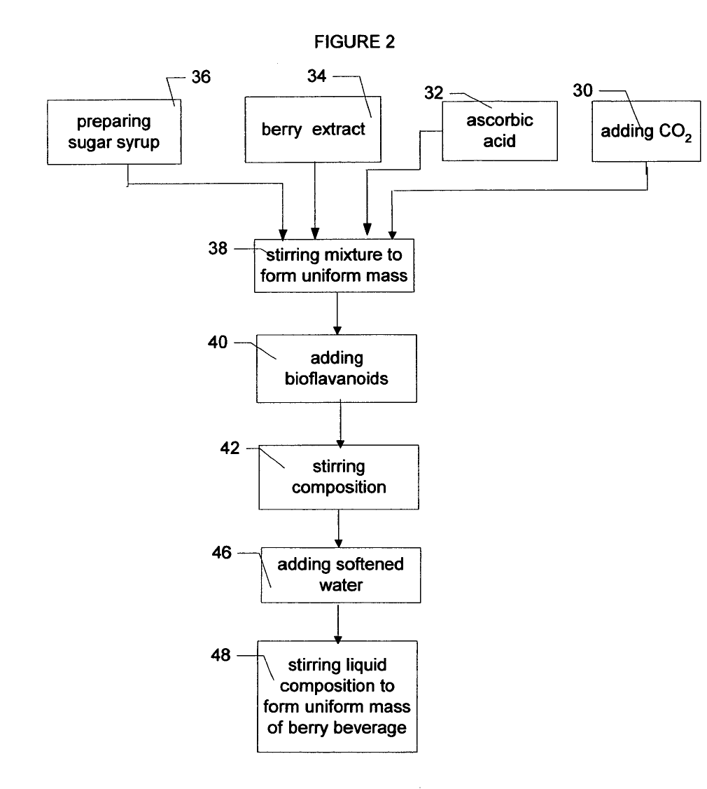

In accordance with a further aspect of the invention, nonalcoholic beverages are based on fruit-based ingredients. Given purely as an example illustrated in FIG. 2, a berry-based beverage may be prepared by mixing together a berry extract, as shown in step 32 with sugar syrup and ascorbic acid as indicated by step 36 and 32, respectively, and finally with CO₂, as indicated by step 30. This liquid composition is then stirred, as indicated by step 38. Further adding bioflavonoids, at shown by step 40, again stirring the composition, as illustrated by step 42, and adding softened water, as shown by step 46, complete preparation of the inventive beverage of step 48. The liquid composition may include the following:

| | |
|---|---|
| Berry extract | about 8.5-9.5 liters; |
| Sugar | about 9.5-11.5 kg; |
| Citric Acid | about 0.1-0.2 kg; |
| Bioflavonoids | about 0.01-0.02 kg; and |
| Water | |

Preferably, the inventive berry beverage is prepared in accordance with the following examples:

### EXAMPLE 1

| | |
|---|---|
| Berry extract | about 9 liters; |
| Sugar | about 10 kg; |
| Citric Acid | about 0.1 kg; |
| Grape Bioflavonoids | 0.01 kg; and |
| Water with low | up to 80.39 kg |
| carbonate concentration | |

### EXAMPLE 2

| | |
|---|---|
| Berry extract | about 9.5 liters; |
| Sugar | about 9.5 kg; |
| Citric Acid | about 0.15 kg; |
| Grape Bioflavonoids | 0.015 kg; and |
| Water with low | up to 79.335 kg |
| carbonate concentration | |

### EXAMPLE 3

| | |
|---|---|
| Berry extract | about 10 liters; |
| Sugar | about 11.5 kg; |
| Citric Acid | about 0.2 kg; |
| Grape Bioflavonoids | about 0.02 kg; and |
| Water with low | up to 79.335 kg |
| carbonate concentration | |

To prepare the inventive beverage, the above-indicated amount of sugar is used for making syrup. The rest of the mentioned ingredients are sequentially added to the sugar syrup. Optionally, a natural color modifier, preferably, having the red color, may be added to the liquid composition. As a result, a prepared red beverage is characterized by the taste and aroma of berry.

This document describes the inventive compositions and method for producing these compositions for illustration purposes only. Neither the specific embodiments of the invention as a whole, nor those of its features limit the general principles underlying the invention. In particular, the invention is not limited to the above disclosed plants, but includes a great variety of herbs and fruits. The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is served by the claims and their equivalents.

What is claimed is:

1. A nonalcoholic beverage comprising:
an extract of a plant selected from the group consisting of herbs, fruits, vegetables and a combination thereof; and
bioflavonoids added to the extract to form a uniform liquid composition.

2. The nonalcoholic beverage of claim 1 further comprising a sugar syrup added to the liquid composition.

3. The nonalcoholic beverage of claim 1 further comprising softened water added to the liquid composition.

4. The nonalcoholic beverage of claim 1 further comprising citric acid added to the liquid composition.

5. The nonalcoholic beverage of claim 1, wherein the herbs include Tarhoon.

6. The nonalcoholic beverage of claim 1, wherein the herbs are selected from the group consisting of feverfew, ginkgo, leaves of green tee and leaves of black tee and a combination thereof.

7. The nonalcoholic beverage of claim 1, wherein the fruits include berries.

8. The nonalcoholic beverage of claim 1, wherein the fruits include blueberries or cherries added to the liquid composition.

9. The nonalcoholic beverage of claim 1, wherein the fruits include grape, grape stem, grape skin or grape seed.

10. The nonalcoholic beverage of claim 1, wherein the bioflavonoids are selected from the group consisting of proanthocyanidins, catehins, kaempferol, hesperin, hesperidin, eriodictyol, quercetin, quercertrin, rutin and a combination thereof.

11. The nonalcoholic beverage of claim 1, wherein the bioflavonoids are added to the extract in an amount ranging between 0.01-0.02 kg to prepare about 100 liters of the nonalcoholic beverage.

12. A nonalcoholic beverage comprising a liquid composition including:
a Tarhoon extract in an amount ranging from about 4 liters to about 5 liters;
a sugar syrup in an amount ranging from about 12.3 to about 12.5 kg;
a citric acid in an amount ranging from about 0.1 to about 0.2 kg;
grape bioflavonoids in an amount ranging from about 0.01 to about 0.02 kg; and
water added to the Tarhoon extract, sugar syrup, citric acid, and grape bioflavonoids in an amount sufficient to prepare about 100 liters of the nonalcoholic beverage.

13. The nonalcoholic beverage of claim 12, wherein the liquid composition includes about 12.3 liters of sugar syrup, about 4 liters of the Tarhoon extract, about 0.01 kg of the grape bioflavonoids having catohins and proanthocyanidins, about 0.1 kg of the citric acid and the water having a reduced carbonate content in amount sufficient to prepare about 100 liters of the nonalcoholic beverage, whereas the nonalcoholic beverage has an increased Vitamin P activity and organoleptic qualities.

14. The nonalcoholic beverage of claim 12, wherein the liquid composition includes about 12.6 liters of sugar syrup, about 4.5 liters of the Tarhoon extract, about 0.015 kg of the grape bioflavonoids having including catohins and proanthocyanidins, about 0.15 kg of the citric acid and the water having a reduced carbonate content in amount sufficient to prepare about 100 liters of the nonalcoholic beverage, whereas the nonalcoholic beverage has an increased Vitamin P activity and organoleptic qualities.

15. The nonalcoholic beverage of claim 12, wherein the liquid composition includes about 12.9 liters of sugar syrup, about 5 liters of the Tarhoon extract, about 0.02 kg of the grape bioflavonoids having catohins and proanthocyanidins, about 0.2 kg of the citric acid and the water having a reduced carbonate content in amount sufficient to prepare about 100 liters of the nonalcoholic beverage, whereas the nonalcoholic beverage has an increased Vitamin P activity and organoleptic qualities.

16. The nonalcoholic beverage of claim 12, wherein a natural color modifier is added to the liquid composition.

17. A nonalcoholic beverage comprising:
a liquid composition including:
an extract made from berries in an amount ranging between about 8.5 to about 9.5 liters;
a sugar syrup in an amount ranging from about 10.5 to about 11.5 kg;
a citric acid in an amount ranging from about 0.1 to about 0.2 kg;
grape bioflavonoids in an amount ranging from about 0.01 to about 0.02 kg; and
water added to the Tarhoon extract, sugar syrup, citric acid, and grape bioflavonoids in an amount sufficient to prepare about 100 liters of the nonalcoholic beverage

18. The nonalcoholic beverage of claim 17, wherein the liquid composition includes about 10 liters of sugar syrup, about 9 liters of the berry extract, about 0.01 kg of the grape bioflavonoids having catohins and proanthocyanidins, about 0.1 kg of the citric acid and about 80.39 liters of water having a reduced carbonate content, whereas the nonalcoholic beverage has an increased Vitamin P activity and organoleptic qualities.

19. The nonalcoholic beverage of claim 17, wherein the liquid composition includes about 9.5 liters of sugar syrup, about 9.5 liters of the berry extract, about 0.015 kg of the grape bioflavonoids having catohins and proanthocyanidins, about 0.15 kg of the citric acid and about 79.335 liters of water having a reduced carbonate content, whereas the nonalcoholic beverage has an increased Vitamin P activity and organoleptic qualities.

20. The nonalcoholic beverage of claim 17, wherein the liquid composition includes about 11.5 liters of sugar syrup, about 10 liters of the berry extract, about 0.02 kg of the grape bioflavonoids having catohins and proanthocyanidins, about 0.2 kg of the citric acid and about 78.28 liters of water having a reduced carbonate content, whereas the nonalcoholic beverage has an increased Vitamin P activity and organoleptic qualities.
